(19) United States
(12) Patent Application Publication
(10) Pub. No.: US 2022/0067623 A1
(43) Pub. Date: Mar. 3, 2022

(54) EVALUATE DEMAND AND PROJECT GO-TO-MARKET RESOURCES

(71) Applicant: International Business Machines Corporation, Armonk, NY (US)

(72) Inventors: James Dunay, Raleigh, NC (US); Andrew Corea, Brookfield, CT (US); Todd Britton, Bernalillo, NM (US)

(21) Appl. No.: 17/003,401

(22) Filed: Aug. 26, 2020

(51) Int. Cl. G06Q 10/06; G06Q 10/10; G06Q 40/06; G06Q 30/00; G06N 20/00; G06N 5/04

(52) U.S. Cl. CPC G06Q 10/06375; G06Q 10/06393; G06Q 10/10; G06N 5/04; G06Q 30/018; G06N 20/00; G06Q 40/06

(57) ABSTRACT

An approach is provided that receives a price input and a quantity input corresponding to use cases that are associated with a revenue producing offering. One trained artificial intelligence model is applied against the price input and the quantity input resulting in predicted revenues corresponding to each of the use cases that are based on a set of defined categories. A second trained artificial intelligence model is applied against the price input and the quantity input, with the second trained artificial intelligence model resulting in a predicted expense data corresponding to each of the use case and a set of predicted go-to-market (GTM) resources at a number of levels corresponding to each of the use cases.

### BACKGROUND

Developing and sizing plans for bookings, revenue, and go-to-market (GTM) is an element of evaluating and executing various types of business investments. These investments can include acquisitions of a business or technology, reselling solutions provided by other companies, and building new solutions for sale in a marketplace. Traditional planning for these transactions is often troublesome as the projected revenue may be unrealistic in both overall amount and growth rate. In addition, the GTM plans may be non-existent or inadequate for certain sales channels or geographies. Difficulties may arise when attempting to understand the resources and investments needed over the course of the project. Furthermore, execution hand-offs after the transaction close or launch date are often inadequate as it is often difficult to implement a GTM plan that supports the projected revenue across the various sales channels and geographies.

### SUMMARY

An approach is provided that receives a price input and a quantity input corresponding to use cases that are associated with a revenue producing offering. One trained artificial intelligence model is applied against the price input and the quantity input resulting in predicted revenues corresponding to each of the use cases that are based on a set of defined categories. A second trained artificial intelligence model is applied against the price input and the quantity input, with the second trained artificial intelligence model resulting in a predicted expense data corresponding to each of the use case and a set of predicted go-to-market (GTM) resources at a number of levels corresponding to each of the use cases.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a diagram that shows the components utilized in go-to-market artificial intelligence model training and go-to-market predictions;

FIG. 4 is a depiction of a flowchart showing the logic used to perform the artificial intelligence training;

FIG. 5 is a depiction of a flowchart showing the logic used to perform revenue model predictions using a trained artificial intelligence system;

FIG. 6 is a depiction of a flowchart showing the logic used to perform expense model predictions using a trained artificial intelligence system; and

FIG. 7 is a depiction of a flowchart showing the logic used to analyze use cases based on calculated key performance indicators derived from predicted revenue and expense models.

### DETAILED DESCRIPTION

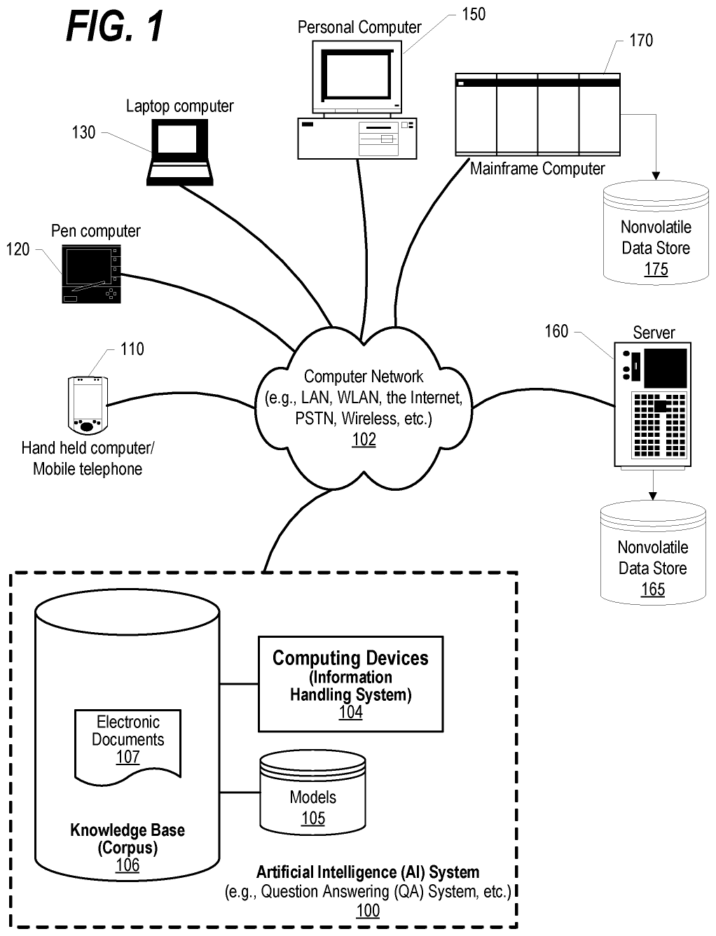

FIGS. 1-7 describe an approach that accommodates the revenue, expense, and go-to-market (GTM) plans with multiple dimensions. Dimensions may include value drivers and different offering types that are delivered by sales channel and geography. While traditional methods have teams building and evaluating models in an ad hoc manner with individual worksheets that generally only meet minimum requirements, the approach instead uses modeling of the required resources to drive the revenue and expense models. Additionally, modern environments are increasingly complex with the shift towards cloud and subscription models that increases the complexity of developing robust GTM plans. The overall approach described herein is quite different from traditional methods resulting in improved capability and analysis. This overall approach accommodates changes found to customer buying patterns recognizing that methods used before to provide solutions may no longer be sufficient given more involved customer requirements for offering readiness and on-going omnichannel delivery of customer experiences.

In the approach presented, both revenue and expense models calculate a number of essential elements based on the characteristics of the use cases, resources, and other investment characteristics. The model is designed to lessen user inputs while creating detailed operating plan information, including bookings, revenue, quantity of each type of GTM resource, and GTM expenses required to deliver the projected investment by geography and sales channel. Revenue and expenses for multiple use cases are projected for a number of years (e.g., ten years, etc.), along with in-method analysis that assists users with in-method testing to ensure use case reasonableness.

The approach provided herein allows the user to define a number of use cases and simplifies user input by prompting for price and quantity (e.g., number of deals, etc.) with entry being provided at a world-wide and yearly level by use case. The approach automatically distributes the data to lower levels on smaller time periods (e.g., quarterly, etc.) for calculation of bookings. The approach provides default distribution rates which can be overridden by the user as desired.

A single revenue model calculates a number of essential model elements based on characteristics of the specific type of revenue (e.g., software as a service (SaaS), perpetual license, term, infrastructure, services, etc.) along with other settings for the use case. The calculated elements may include recognized revenue, annual recurring revenue (ARR), deferred revenue, expansion bookings, expansion revenue, customer churn, and royalties (e.g., in OEM situations, etc.).

The approach operates to understand the number of GTM resources required globally to create a plan suitable for execution hand off. The following data is distributed to geography and sales channel levels: deal counts, average selling prices, bookings (e.g., land, expand, renewal subscriptions, etc.), revenue (e.g., land license, land subscription, expand license, expand subscription, renewal subscriptions, etc.), ARR, churn, and deferred revenue. Likewise, to simplify input the approach provides default distribution percentages that can be overridden by the user as desired.

At this point, the model being developed has derived extensive projected information about the potential business from a few simple inputs by the user. This information is then fed into the expense model that is provided by the approach. Based on default productivity rates and headcount costs, both of which can be overridden by the user, for a number of GTM roles for different revenue types, the quantity of each GTM resource needed for the business opportunity is predicted by both geography and sales channel.

The approach further utilizes several key performance indicators (KPIs) that can assist the user and decision makers in adjusting the resources and expenses to achieve a more optimal level. The approach further provides reports that document resource and expenses required by geography and sales channel to drive the projected revenue. This data can then be provided to key personnel, integration teams, and sales leaders during the execution and hand-off phases.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts a schematic diagram of one illustrative embodiment of artificial intelligence (AI) system 100, such as a question/answer creation (QA) system, in a computer network 102. AI system 100 may include a knowledge manager computing device 104 (comprising one or more processors and one or more memories, and potentially any other computing device elements generally known in the art including buses, storage devices, communication interfaces, and the like) that connects AI system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. AI system 100 and network 102 may enable question/answer (QA) generation functionality for one or more content users. Other embodiments of AI system 100 may be used with components, systems, sub-systems, and/or devices other than those that are depicted herein.

AI system 100 uses AI model 105 that is a result of training the AI system. The model is a mathematical model that generates predictions by finding patterns in the data stored in corpus 106. In artificial intelligence, AI models 105 are based on the reasoning that works on methods in the AI system. AI models 105 observe data in corpus 106 to derive conclusions and make predictions about such data.

AI system 100 may be configured to receive inputs from various sources. For example, AI system 100 may receive input from the network 102, a corpus of electronic documents 107 or other data, a content creator, content users, and other possible sources of input. In one embodiment, some or all of the inputs to AI system 100 may be routed through the network 102. The various computing devices on the network 102 may include access points for content creators and content users. Some of the computing devices may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in electronic documents 107 for use as part of a corpus of data with AI system 100. Electronic documents 107 may include any file, text, article, or source of data for use in AI system 100. Content users may access AI system 100 via a network connection or an Internet connection to the network 102, and may input questions to AI system 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. Semantic data 108 is stored as part of the knowledge base 106. In one embodiment, the process sends well-formed questions (e.g., natural language questions, etc.) to the knowledge manager. AI system 100 may interpret the question and provide a response to the content user containing one or more answers to the question. In some embodiments, AI system 100 may provide a response to users in a ranked list of answers.

In some illustrative embodiments, AI system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question.

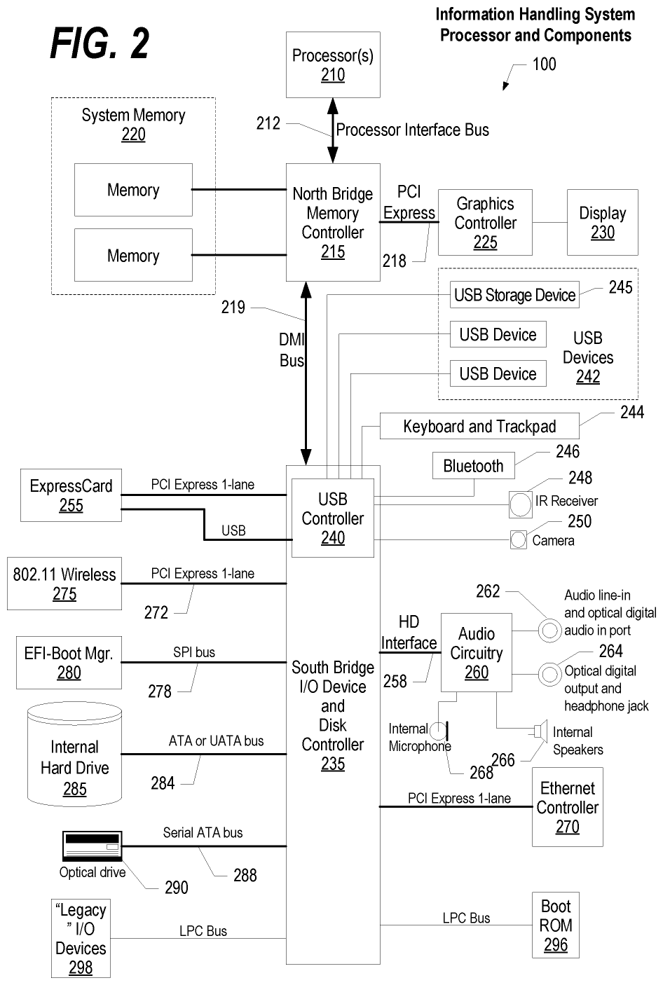

Types of information handling systems that can utilize AI system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE .802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

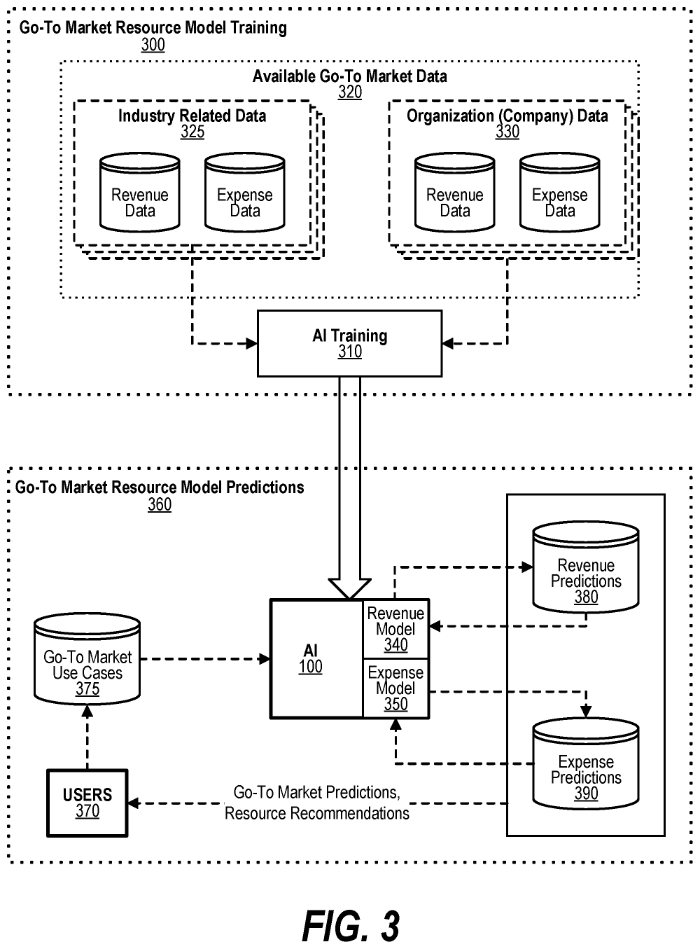

FIG. 3 is a diagram that shows the components utilized in go-to-market artificial intelligence model training and go-to-market predictions. Go-to-market (GTM) resource model training 300 shows the components utilized in training artificial intelligence (AI) system 100 with data needed for the AI system to make GTM predictions regarding future product offerings by an organization, such as a company, corporation, etc. AI training process 300 inputs industry related data 325 that includes industry-related revenue data and industry-related expense data to train AI system 100. In addition, organization-specific data 330 that includes revenue data corresponding to the organization as well as expense data corresponding to the organization are also used as inputs by process 310 to train AI system 100.

The trained AI system 100 is then used to make GTM resource model predictions based on the training that the AI system received as described above. GTM use cases are prepared that include a price and a quantity. These use cases are input to the trained AI system 100 that results in the AI system making revenue and expense predictions corresponding to each of the use cases. The expense data also includes GTM resources for each of the use cases with the GTM resources being predicted GTM resources that the trained model predicts are needed for the use case. GTM resources might include headcount in various organizational areas and other GTM resources.

The AI training resulted in trained revenue model 340 as well as trained expense model 350. AI system 100 uses trained revenue model 340 to make revenue predictions that are depicted as being stored in data store 380. The GTM resource predictions, revenue predictions, and expense predictions are output to users 370. One or more of these uses develops the GTM use cases that are stored in data store 375. In addition, if the predictions for all of the use cases are unacceptable insofar as implementation is concerned, then one of users 370 alters one or more of the use cases and reperforms the AI prediction of revenue and expenses for each of the altered use cases. This alteration of use cases continues until a use cases is identified as being acceptable and, based on organizational criteria, as being superior to other use cases.

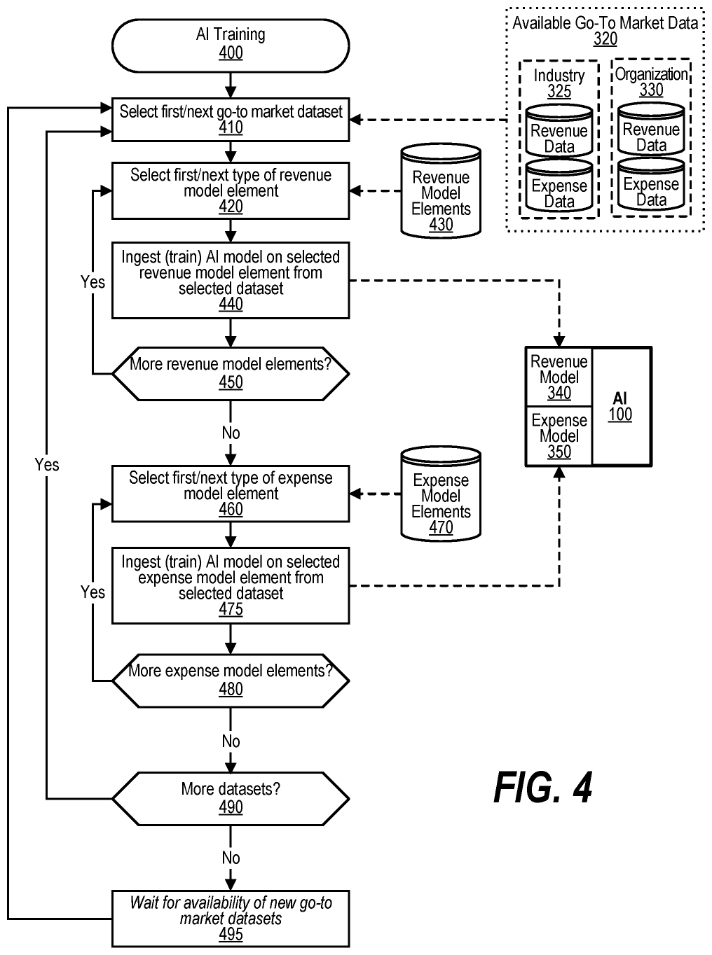

FIG. 4 is a depiction of a flowchart showing the logic used to perform the artificial intelligence training. FIG. 4 processing commences at 400 and shows the steps taken by a process that trains the artificial intelligence (AI) system used to make revenue, expense, and go-to-market predictions. At step 410, the process selects the first go-to market dataset from datasets 320. These datasets include revenue and expense data for both the industry in which the predictions are being performed as well as the specific organization for which the predictions are being performed.

At step 420, the process selects the first type of revenue model element from data store 430. The data model element may be a type of revenue, such as services, subscriptions, SaaS, etc. At step 440, the process ingests (trains) AI revenue model 340 on the selected revenue model element from the selected dataset. Once trained, AI system 100 utilizes AI revenue model 340 to make predictions about the revenue for a planned revenue producing project, such as a new software service or software product. The process determines as to whether there are additional revenue model elements to select and process for the selected dataset (decision 450). If there are additional revenue model elements to select and process for the selected dataset, then decision 450 branches to the ‘yes’ branch which loops back to step 420 to select and process the next type of revenue model element. This looping continues until all of the revenue model elements have been processed for the selected dataset, at which point decision 450 branches to the ‘no’ branch exiting the loop.

At step 460, the process selects the first type of expense model element from data store 470. The expense data model element is an expense, such as data scientist, sales and marketing, customer success, programmers, management and overhead costs, etc., that are used to create, deliver, and support a revenue-producing project such as a new service or software product, At step 475, the process ingests (trains) AI expense model 350 on the selected expense model element using the selected dataset. Once trained, AI system 100 utilizes AI expense model 350 to make predictions about the expenses and go-to-market resources needed for a planned revenue producing project, such as a new software service or software product. The process determines as to whether there are additional expense model elements to select and process for the selected dataset (decision 480). If there are additional expense model elements to select and process for the selected dataset, then decision 480 branches to the ‘yes’ branch which loops back to step 460 to select and process the next type of expense model element. This looping continues until all of the expense model elements have been processed for the selected dataset, at which point decision 480 branches to the ‘no’ branch exiting the loop.

The process determines as to whether there are more datasets to process in order to train the AI system with revenue and expense models (decision 490). If there are more datasets to process, then decision 490 branches to the ‘yes’ branch which loops back to step 410 to select and process the next dataset as described above. This looping continues until all of the datasets have been processed, at which point decision 490 branches to the ‘no’ branch exiting the loop. At step 495, the process waits for the availability of additional go-to market datasets that can be used to train the AI system. When additional datasets are available, processing loops back to step 410 to select and process such additional datasets as described above.

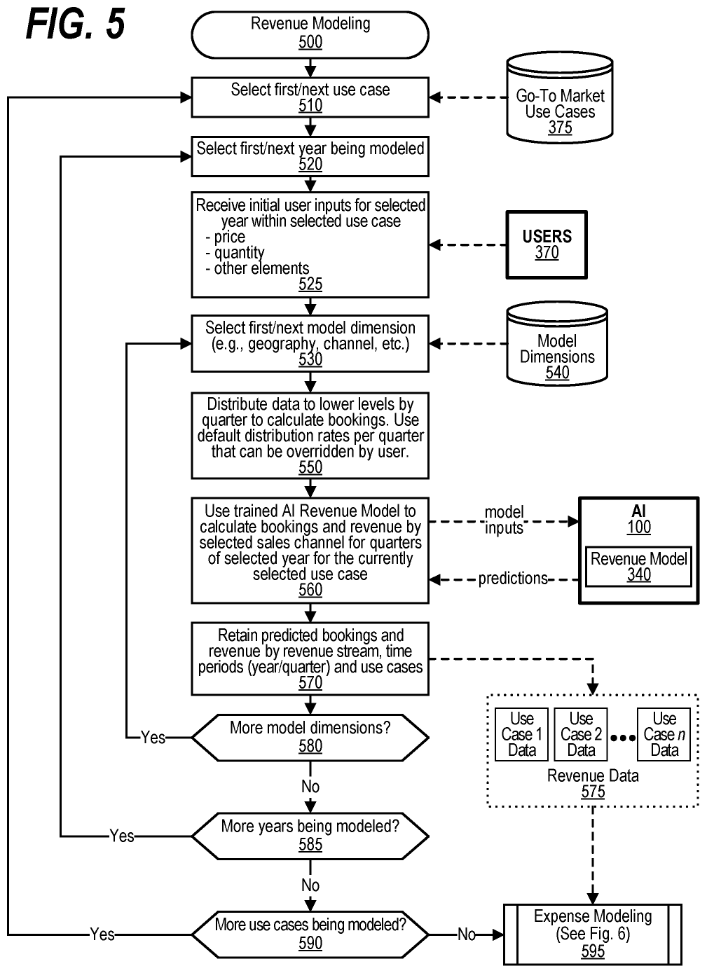

FIG. 5 is a depiction of a flowchart showing the logic used to perform revenue model predictions using a trained artificial intelligence system. FIG. 5 processing commences at 500 and shows the steps taken by a process that uses revenue modeling in the trained AI system to make revenue predictions corresponding to a revenue producing project. At step 510, the process selects the first use case from the set of go-to-market use cases 375. In one embodiment, the use cases are created and updated by the user to direct the system on use case predictions.

At step 520, the process selects the first time period (e.g., year, etc.) that is being modeled. At step 525, the process receives initial user inputs for the selected year within the selected use case. These inputs include price and quantity and other elements as might be needed to support the modeling for the use case. At step 530, the process selects the first model dimension (e.g., geography, channel, etc.) from data store 540. At step 550, the process distributes data to lower levels by smaller time periods within the selected time period (e.g., quarter, month, etc.) to calculate bookings. In one embodiment, the system uses default distribution rates per time period that can be overridden by user as desired.

At step 560, the process uses AI system 100's trained AI Revenue Model 340 to predict calculated bookings and revenue by the selected model dimension for the time periods (quarters, months, etc.) of selected major time period (year) for the currently selected use case. As shown, step 560 provides model inputs (e.g., price, quantity, etc.) to the AI system and receives predicted values back from the AI system with the predicted values based on the revenue model training that was performed as shown in FIG. 4.

At step 570, the process retains the predicted bookings and revenue for the selected model dimension, for the selected time periods (year/quarter/etc.) that correspond to the selected use case. This revenue data for use cases is stored in revenue data 575.

The process determines as to whether there are more model dimensions to process (decision 580). If there are more model dimensions to process, then decision 580 branches to the ‘yes’ branch which loops back to step 530 to select and process the next model dimension as described above. This looping continues until all of the model dimensions have been processed, at which point decision 580 branches to the ‘no’ branch exiting the loop.

The process determines as to whether there are more major time periods (e.g., years, etc.) that are being modeled (decision 585). If there are more major time periods being modeled, then decision 585 branches to the ‘yes’ branch which loops back to step 520 to select and process the model dimensions for the next major time period. This looping continues until all of the major time periods have been processed, at which point decision 585 branches to the ‘no’ branch exiting the loop.

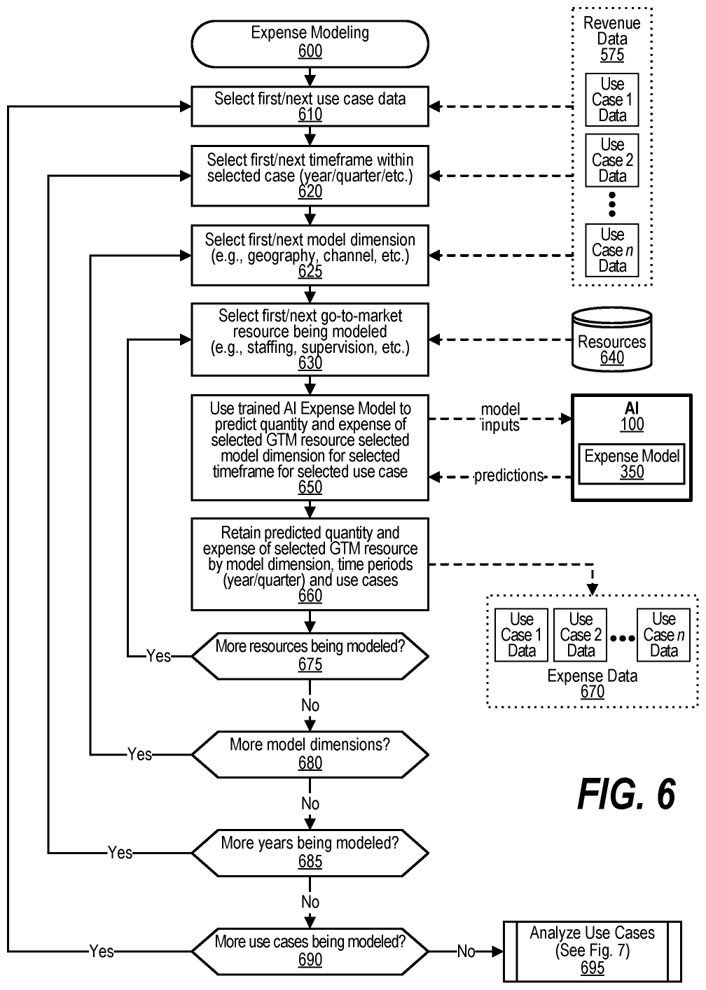

The process determines as to whether there are more use cases being modeled (decision 590). If there are more use cases being modeled, then decision 590 branches to the ‘yes’ branch which loops back to step 510 to select and process the next use case as described above. This looping continues until all of the use cases have been processed, at which point decision 590 branches to the ‘no’ branch exiting the loop. At predefined process 595, the process performs the Expense Modeling routine (see FIG. 6 and corresponding text for processing details).

FIG. 6 processing commences at 600 and shows the steps taken by a process that uses expense modeling in the trained AI system to make expense and go-to-market resource predictions corresponding to a revenue producing project. At step 610, the process selects the first use case data. In one embodiment, the use case data is selected from the previously calculated revenue data 575 for the use cases with this data including the use case data, time periods, user inputs, model dimensions, and the like.

At step 620, the process selects the first smaller timeframe within the selected major time period for the selected use case (year/quarter/etc.). At step 625, the process selects the first model dimension (e.g., geography, channel, etc.) that was also used during the revenue prediction process shown in FIG. 5. At step 630, the process selects the first go-to-market resource being modeled (e.g., staffing, supervision, etc.) from data store 640.

At step 650, the process uses trained AI system 100's Expense Model 350 to predict quantity and expense of the selected go-to-market (GTM) resource for the selected model dimension of the selected timeframe of the selected use case. As shown, step 650 provides model inputs to AI system 100 and receives expense prediction data back from the AI system. At step 660, the process retains the predicted quantity and expense data corresponding to the selected GTM resource by model dimension, time periods (e.g., year, quarter, etc.) use case in expense data 670.

The process determines as to whether there are more go-to-market resources that are being modeled (decision 675). If there are more go-to-market resources that are being modeled, then decision 675 branches to the ‘yes’ branch which loops back to step 630 to select and model the next GTM resource as described above. This looping continues until there are no more GTM resources to model, at which point decision 675 branches to the ‘no’ branch exiting the loop.

The process determines as to whether there are more model dimensions to process (decision 680). If there are more model dimensions to process, then decision 680 branches to the ‘yes’ branch which loops back to step 625 to select the next model dimension and process the GTM resources for the next model dimension as described above. This looping continues until all of the model dimensions have been processed, at which point decision 680 branches to the ‘no’ branch exiting the loop.

The process determines as to whether there are more major time periods (e.g., years, etc.) that are being modeled (decision 685). If there are more major time periods being modeled, then decision 685 branches to the ‘yes’ branch which loops back to step 620 to select and process the selected use case for the next time period. This looping continues until all of the time periods have been processed, at which point decision 685 branches to the ‘no’ branch exiting the loop.

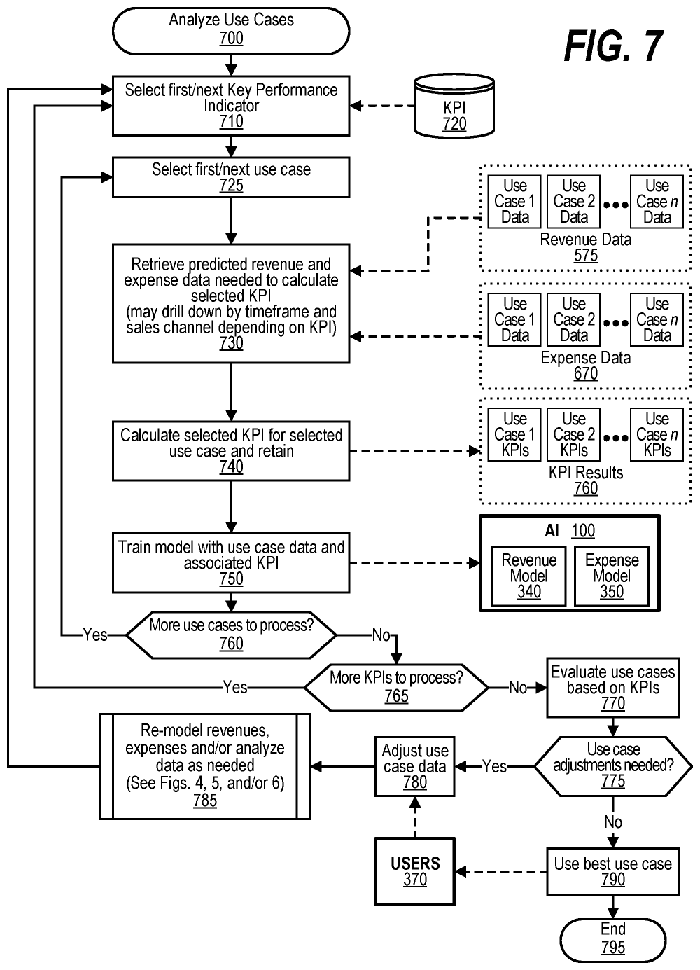

The process determines as to whether there are more use cases that are being modeled (decision 690). If there are more use cases that are being modeled, then decision 690 branches to the ‘yes’ branch which loops back to step 610 to select and process the next use case as described above. This looping continues until all use cases have been processed, at which point decision 690 branches to the ‘no’ branch exiting the loop. At predefined process 695, the process performs the Analyze Use Cases routine (see FIG. 7 and corresponding text for processing details).

FIG. 7 is a depiction of a flowchart showing the logic used to analyze use cases based on calculated key performance indicators derived from predicted revenue and expense models. FIG. 7 processing commences at 700 and shows the steps taken by a process that analyze use case data to determine whether a use case is suitable for implementation. At step 710, the process selects the first Key Performance Indicator (KPI) from the set of KPIs stored in data store 720.

At step 725, the process selects the first use case that was processed. At step 730, the process retrieves the predicted revenue data (from data 575) and expense data (from data 670) that are needed to calculate the selected KPI. The use case data that is selected may be by a particular timeframe and model dimension depending on the specific KPI that is being processed.

At step 740, the process calculates the selected KPI for the selected use case and retains the KPI results in data 760. In one embodiment, at step 750, the process further trains the AI model (revenue model 340 and/or expense model 350) with the use case data and the associated KPI results.

The process determines as to whether there are more use cases to select and process (decision 760). If there are more use cases to select and process, then decision 760 branches to the ‘yes’ branch which loops back to step 725 to select and process the next use case as described above. This looping continues until all of the use cases have been processed, at which point decision 760 branches to the ‘no’ branch exiting the loop.

The process then determines whether there are more KPIs to select and process (decision 765). If there are more KPIs to select and process, then decision 765 branches to the ‘yes’ branch which loops back to step 710 to select and process the next KPI for each of the use cases as described above. This looping continues until all of the KPIs have been processed, at which point decision 765 branches to the ‘no’ branch exiting the loop.

At step 770, the process evaluates use cases based on their respective KPIs. Based on this evaluation, the process determines whether use case adjustments needed because none of the use cases was deemed adequate or appropriate for implementation (decision 775). If use case adjustments needed, then decision 775 branches to the ‘yes’ branch whereupon, at step 780, user 370 adjusts use case data used by one or more of the use cases and, at predefined process 785, one or more of the processes shown in FIGS. 4, 5, and 6 are re-performed as needed to re-model the revenues, expenses, go-to-market resources and further analyze the use case data as previously described.

Returning to decision 775, if further use case adjustments are not needed as at least one of the use cases is deemed adequate for implementation, then decision 775 branches to the ‘no’ branch whereupon, at step 790, the best acceptable use case is selected for implementation and details regarding the selected use case (e.g., predicted revenue data, predicted expense data, predicted go-to-market resource data, etc., is provided to one or more users 370 for implementation. FIG. 7 processing thereafter ends at 795.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes a processor and a memory accessible by the processor, the method comprising:
receiving a price input and a quantity input corresponding to a plurality of use cases associated with a revenue producing offering;
applying a first trained artificial intelligence model against the price input and the quantity input, wherein the first trained artificial intelligence model outputs a predicted revenue corresponding to each of the use cases based on a plurality of defined categories; and
applying a second trained artificial intelligence model against the price input and the quantity input, wherein the second trained artificial intelligence model outputs a predicted expense data corresponding to each of the use case and a set of predicted go-to-market (GTM) resources at a plurality of levels corresponding to each of the use cases.

2. The method of claim 1 further comprising
calculating a plurality of key performance indicators (KPIs) based on the predicted revenue and predicted expense data corresponding to each of the use cases;
evaluating the plurality of use cases based on the calculated KPIs corresponding to each of the use cases; and
selecting one of the use cases to implement based on the evaluation.

3. The method of claim 1 further comprising
calculating a plurality of key performance indicators (KPIs) based on the predicted revenue and predicted expense data corresponding to each of the use cases;
evaluating the plurality of use cases based on the calculated KPIs corresponding to each of the use cases;
adjusting at least one of the use cases in response to a non-selection of any of the use cases after performing the evaluation; and
re-applying the first and second trained artificial intelligence models to the adjusted use cases.

4. The method of claim 1 further comprising
prior to applying the first and second trained artificial intelligence models:
selecting a plurality of revenue model elements applicable to an organization corresponding to the revenue producing offering;
training the first artificial intelligence model using the plurality of selected revenue model elements;
selecting a plurality of expense model elements applicable to the organization corresponding to the revenue producing offering; and
training the second artificial intelligence model using the plurality of selected expense model elements.

5. The method of claim 1 further comprising
outputting a report of the set of GTM resources corresponding to a selected one of the use cases, wherein the selected use case is planned for implementation; and
providing the report to one or more implementors.

6. The method of claim 1 further comprising
breaking the revenue, the expense data, and the GTM resources down by sales area, wherein the sales area include one or more geographies and one or more sales channels.

7. The method of claim 6 further comprising
providing a set of data by one or more categories and by the sales area, wherein at least one of the categories is selected from the group consisting of one or more Deal counts, one or more Average Selling Prices, one or more Bookings (Land, Expand, renewal subscriptions), one or more Revenues (land license, land subscription, expand license, expand subscription, renewal subscriptions), one or more ARR, one or more Churn, and one or more deferred revenues.

8. An information handling system comprising:
one or more processors;
a memory coupled to at least one of the processors; and
a set of computer program instructions stored in the memory and executed by at least one of the processors in order to perform actions comprising:
receiving a price input and a quantity input corresponding to a plurality of use cases associated with a revenue producing offering;
applying a first trained artificial intelligence model against the price input and the quantity input, wherein the first trained artificial intelligence model outputs a predicted revenue corresponding to each of the use cases based on a plurality of defined categories; and
applying a second trained artificial intelligence model against the price input and the quantity input, wherein the second trained artificial intelligence model outputs a predicted expense data corresponding to each of the use case and a set of predicted go-to-market (GTM) resources at a plurality of levels corresponding to each of the use cases.

9. The information handling system of claim 8 wherein the actions further comprise
calculating a plurality of key performance indicators (KPIs) based on the predicted revenue and predicted expense data corresponding to each of the use cases;
evaluating the plurality of use cases based on the calculated KPIs corresponding to each of the use cases; and
selecting one of the use cases to implement based on the evaluation.

10. The information handling system of claim 8 wherein the actions further comprise
calculating a plurality of key performance indicators (KPIs) based on the predicted revenue and predicted expense data corresponding to each of the use cases;
evaluating the plurality of use cases based on the calculated KPIs corresponding to each of the use cases;
adjusting at least one of the use cases in response to a non-selection of any of the use cases after performing the evaluation; and
re-applying the first and second trained artificial intelligence models to the adjusted use cases.

11. The information handling system of claim 8 wherein the actions further comprise
prior to applying the first and second trained artificial intelligence models:
selecting a plurality of revenue model elements applicable to an organization corresponding to the revenue producing offering;
training the first artificial intelligence model using the plurality of selected revenue model elements;
selecting a plurality of expense model elements applicable to the organization corresponding to the revenue producing offering; and
training the second artificial intelligence model using the plurality of selected expense model elements.

12. The information handling system of claim 8 wherein the actions further comprise
outputting a report of the set of GTM resources corresponding to a selected one of the use cases, wherein the selected use case is planned for implementation; and
providing the report to one or more implementors.

13. The information handling system of claim 8 wherein the actions further comprise
breaking the revenue, the expense data, and the GTM resources down by sales area, wherein the sales area include one or more geographies and one or more sales channels.

14. The information handling system of claim 6 wherein the actions further comprise
providing a set of data by one or more categories and by the sales area, wherein at least one of the categories is selected from the group consisting of one or more Deal counts, one or more Average Selling Prices, one or more Bookings (Land, Expand, renewal subscriptions), one or more Revenues (land license, land subscription, expand license, expand subscription, renewal subscriptions), one or more ARR, one or more Churn, and one or more deferred revenues.

15. A computer program product stored in a computer readable storage medium, comprising computer program code that, when executed by an information handling system, performs actions comprising:
receiving a price input and a quantity input corresponding to a plurality of use cases associated with a revenue producing offering;
applying a first trained artificial intelligence model against the price input and the quantity input, wherein the first trained artificial intelligence model outputs a predicted revenue corresponding to each of the use cases based on a plurality of defined categories; and
applying a second trained artificial intelligence model against the price input and the quantity input, wherein the second trained artificial intelligence model outputs a predicted expense data corresponding to each of the use case and a set of predicted go-to-market (GTM) resources at a plurality of levels corresponding to each of the use cases.

16. The computer program product of claim 15 wherein the actions further comprise
calculating a plurality of key performance indicators (KPIs) based on the predicted revenue and predicted expense data corresponding to each of evaluating the plurality of use cases based on the calculated KPIs corresponding to each of the use cases; and
selecting one of the use cases to implement based on the evaluation.

17. The computer program product of claim 15 wherein the actions further comprise
calculating a plurality of key performance indicators (KPIs) based on the predicted revenue and predicted expense data corresponding to each of the use cases;
evaluating the plurality of use cases based on the calculated KPIs corresponding to each of the use cases;
adjusting at least one of the use cases in response to a non-selection of any of the use cases after performing the evaluation; and
re-applying the first and second trained artificial intelligence models to the adjusted use cases.

18. The computer program product of claim 15 wherein the actions further comprise
prior to applying the first and second trained artificial intelligence models:
selecting a plurality of revenue model elements applicable to an organization corresponding to the revenue producing offering;
training the first artificial intelligence model using the plurality of selected revenue model elements;
selecting a plurality of expense model elements applicable to the organization corresponding to the revenue producing offering; and
training the second artificial intelligence model using the plurality of

19. The computer program product of claim 15 wherein the actions further comprise
outputting a report of the set of GTM resources corresponding to a selected one of the use cases, wherein the selected use case is planned for implementation; and
providing the report to one or more implementors.

20. The computer program product of claim 15 wherein the actions further comprise
breaking the revenue, the expense data, and the GTM resources down by sales area, wherein the sales area include one or more geographies and
